(19) United States
(12) Patent Application Publication
(10) Pub. No.: US 2009/0291693 A1
(43) Pub. Date: Nov. 26, 2009

(54) METHOD FOR ESTIMATING POSITION OF MOBILE TERMINAL IN WIRELESS NETWORK

(75) Inventors: Byung Doo KIM, Daejeon (KR); Seong Yun CHO, Daejeon (KR); Young Su CHO, Seoul (KR); Wan Sik CHOI, Daejeon (KR)

Correspondence Address: Muncy, Geissler, Olds & Lowe, PLLC, P.O. BOX 1364, FAIRFAX, VA, 22038-1364, US

(73) Assignee: ELECTRONICS AND TELECOMMUNICATIONS RESEARCH INSTITUTE, Daejeon (KR)

(21) Appl. No.: 12/418,739

(22) Filed: Apr. 6, 2009

(30) Foreign Application Priority Data
May 20, 2008 (KR) 10-2008-0046516

(51) Int. Cl. H04W 24/00

(52) U.S. Cl. 455/456.1

(57) ABSTRACT

Provided is a method for estimating a position of a mobile terminal in a wireless network. In the method according to the present invention, difference values between squared signal arrival times of base stations are used to estimate the position of the mobile terminal.

### CROSS-REFERENCE TO RELATED APPLICATION

This application claims priority to and the benefit of Korean Patent Application No. 10-2008-0046516 filed in the Korean Intellectual Property Office on May 20, 2008 the entire contents of which are incorporated herein by reference.

### BACKGROUND OF THE INVENTION

(a) Field of the Invention

The present invention relates to a method for estimating a position of a mobile terminal in a wireless network.

(b) Description of the Related Art

Recently, the need for position information has been increased, and research for providing position information through various means such as a GSM (Global System for Mobile Telecommunication), a CDMA (Code Division Multiple Access), a W-CDMA (Wideband-CDMA), wireless LAN (Local Area Network), and a UWB (Ultra Wide Band) has been processed.

In addition, a plurality of methods for estimating a position using a wireless network such as a TOA (Time Of Arrival), a TDOA (Time Difference Of Arrival), a AOA (Angle Of Arrival), an RSS (Received Signal Strength) have been researched.

The method using the TOA among the plurality of methods has a merit of providing relatively correct position information.

However, in order to estimate a position of a mobile terminal using the TOA, there is a drawback of solving a nonlinear equation of a TOA measured value and the position of the mobile terminal.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide an advanced method for estimating a position of a mobile terminal.

An exemplary embodiment of the present invention provides a method for estimating a position of a mobile terminal. The method includes: obtaining a signal arrival time and position coordinates of a first base station and a signal arrival time and position coordinates of a second base station; calculating a difference value between a squared signal arrival time of the first base station and a squared signal arrival time of the second base station; and estimating the position of the mobile terminal by using the difference value, the position coordinates of the first base station, the position coordinates of the second base station, and a measurement error covariance to the signal arrival time of the first base station and the signal arrival time of the second base station.

According to exemplary embodiments of the present invention, it is possible to improve the accuracy of position estimation because the signal arrive times are measured by the plurality of base stations and the position estimation of the mobile terminal is performed using differences between values obtained by squaring the signal arrive times.

### BRIEF DESCRIPTION OF THE DRAWINGS

FIG. 1 shows a wireless network of an exemplary embodiment of the present invention.

FIG. 2 shows a flowchart of a method for estimating a position of a mobile terminal according to an exemplary embodiment of the present invention.

FIG. 3 shows a graph that compares an accumulated distribution of horizontal position error of a mobile terminal according to an exemplary embodiment of the present invention with that of the prior art.

FIG. 4 shows a graph that compares an accumulated distribution of vertical position error of a mobile terminal according to an exemplary embodiment of the present invention with that of the prior art.

### DETAILED DESCRIPTION OF THE EMBODIMENTS

In the following detailed description, only certain exemplary embodiments of the present invention have been shown and described, simply by way of illustration.

As those skilled in the art would realize, the described embodiments may be modified in various different ways, all without departing from the spirit or scope of the present invention.

Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and operation and can be implemented by hardware components or software components and combinations thereof.

In this specification, a mobile terminal (MT) may refer to a terminal, a mobile station (MS), a subscriber station (SS), a portable subscriber station (PSS), user equipment (UE), or an access terminal (AT). The mobile terminal may include all or part of the functions of the mobile station, the subscriber station, the portable subscriber station, and the user equipment. In this specification, a base station (BS) may refer to an access point (AP), a radio access station (RAS), a node B, a base transceiver station (BTS), or an MMR (mobile multihop relay)-BS. The base station may include all or part of the functions of the access point, the radio access station, the node B, the base transceiver station, and the MMR-BS.

Now, a method for estimating a position of a mobile terminal an exemplary embodiment of the present invention will be described in detail with reference to the accompanying drawings.

Hereinafter, time that represents how long it takes for a signal transmitted from the mobile terminal to arrive at a base station is denoted as signal arrival time (it will be called TOA (Time Of Arrival)).

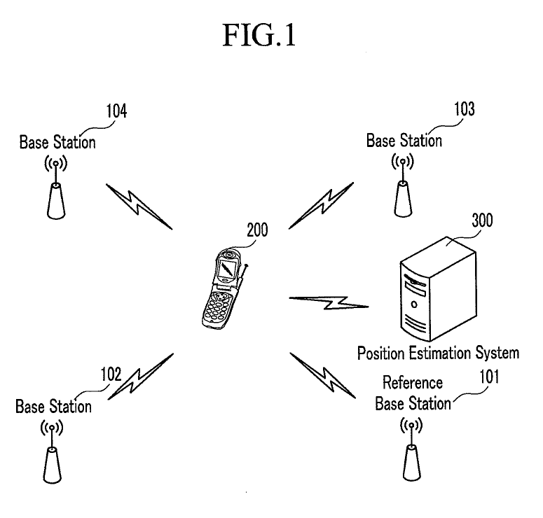

FIG. 1 shows a wireless network of an exemplary embodiment of the present invention.

Referring to FIG. 1, a position estimating system 300 to estimate a position of a mobile terminal 200 in the wireless network uses a plurality of TOAs of base stations (101 to 104).

That is, the position estimating system 300 determines one among the plurality of base stations (101 to 104) as a reference station 101, and estimates a position coordinate of the mobile terminal 200 based on difference values between a value that is obtained by squaring the TOA of the reference base station 101 and values that are obtained by squaring each TOA of the other base stations 102 to 104.

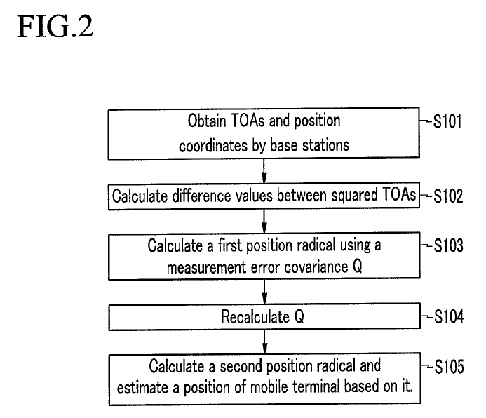

FIG. 2 shows a flowchart of a method for estimating a position of a mobile terminal according to an exemplary embodiment of the present invention.

First, deriving a linear equation for estimating the position of the mobile terminal 200 using the difference values between the squared TOAs of base stations based on Equations 1 to 8 will be described.

A TOA between an n-th base station and the mobile terminal 200 will be shown as in the following Equation 1.

\tilde{r}ₙ=rₙ+wₙ

rₙ=\sqrt{(xₙ−x)²+(yₙ−y)²+(zₙ−z)²} (Equation 1)

Here, \tilde{r}ₙ represents the TOA between the n-th base station and the mobile terminal 200.

In addition, wₙ represents a TOA measurement error of the n-th base station and has the average value of “0”. It is assumed that wₙ is a random node having a Gaussian distribution.

rₙ represents a distance between the n-th base station and the mobile terminal 200, (xₙ,yₙ,zₙ) represents position coordinates of the n-th base station, and (x,y,z) represents position coordinates of the mobile terminal 200.

Based on Equation 1, the difference values between square TOAs of base stations will be shown as in the following Equation 2.

\tilde{r}ₙ²−\tilde{r}₀²=kₙ−k₀−2x(xₙ−x₀)−2y(yₙ−y₀)−2z(zₙ−y₀)+2rₙwₙ−2r₀w₀+wₙ²−w₀²

kₙ=xₙ²+yₙ²+zₙ²

k₀=x₀²+y₀²+z₀² (Equation 2)

Here, \tilde{r}₀ represents a TOA of the reference base station, the reference base station being selected from among a plurality of base stations that communicate with the mobile terminal 200.

Meanwhile, according to Equation 1, it is possible to represent \tilde{r}₀=r₀+w₀, wherein r₀ represents a distance between the reference base station and the mobile station 200 and w₀ represents a TOA measurement error of the reference base station.

In addition, (x₀,y₀,z₀) represents position coordinates of the reference base station.

When arranging Equation 2, Equation 2 will be described as the following Equation 3.

$$\frac{1}{2} ( {\tilde{r}}_{n}^{2} - {\tilde{r}}_{0}^{2} - {k}_{n} + {k}_{0} ) = x ( {x}_{0} - {x}_{n} ) + y ( {y}_{0} - {y}_{n} ) + z ( {z}_{0} - {y}_{n} ) + {r}_{n} {w}_{n} - {r}_{0} {w}_{0} + \frac{1}{2} ( {w}_{n}^{2} - {w}_{0}^{2} ) \qquad ( Equation 3 )$$

When it is assumed

$${ρ}_{n 0} = \frac{1}{2} ( {\tilde{r}}_{n}^{2} - {\tilde{r}}_{0}^{2} - {k}_{n} + {k}_{0} )$$

in Equation 3, Equation 3 will be described as the following Equation 4.

$${ρ}_{n 0} = x ( {x}_{0} - {x}_{n} ) + y ( {y}_{0} - {y}_{n} ) + z ( {z}_{0} - {z}_{n} ) + {r}_{n} {w}_{n} - {r}_{0} {w}_{0} + \frac{1}{2} ( {w}_{n}^{2} - {w}_{0}^{2} ) \qquad ( Equation 4 )$$

Here, when it is assumed that a TOA is quite smaller than a TOA measurement error, (wₙ²−w₀²) also becomes quite small and Equation 4 will be approximated to the following Equation 5.

ρₙ₀≈x(x₀−xₙ)+y(y₀−yₙ)+z(z₀−zₙ)+rₙwₙ−r₀w₀ (Equation 5)

When generalizing Equation 5 to m number of base stations, Equation 5 will be described as the following Equation 6.

(Equation 6)

A TOA measurement error covariance to v in Equation 6 will be shown as in the following Equation 7.

$$Q = E \{ v \cdot {v}^{T} \} = {σ}_{w}^{2} [ \begin{matrix}{r}_{1}^{2} + {r}_{0}^{2} & {r}_{0}^{2} & … & {r}_{0}^{2} \\ {r}_{0}^{2} & {r}_{2}^{2} + {r}_{0}^{2} & … & {r}_{0}^{2} \\ ⋮ & ⋮ & ⋰ & ⋮ \\ {r}_{0}^{2} & {r}_{0}^{2} & … & {r}_{m}^{2} + {r}_{0}^{2}\end{matrix} ] \qquad ( Equation 7 )$$

Here, σ_{w}² represents a variance of a TOA.

Meanwhile, when applying a least squares method to Equation 6, a linear equation for estimating a position that is comprised of the difference values between the squared TOAs of base stations, the position coordinates of base stations, the TOA measurement error covariance, the position coordinates of the mobile terminal 200, and so on will be shown as in the following Equation 8.

Here, since a method for deriving Equation 8 by applying the least squares method to Equation 7 is known to a person of ordinary skill in the art, a detailed description for the method for deriving Equation 8 will be omitted.

x=(G^{T}Q⁻¹G)⁻¹G^{T}Q⁻¹z (Equation 8)

Referring to FIG. 2, the position estimating system 300 first obtains TOAs by the plurality of base stations including the reference base station and obtains position coordinates that correspond to each of the plurality of base stations (S101). Then, the position estimating system 300 calculates difference values between a squared TOA of the reference station and each of squared TOAs of the other base stations (S102).

The position estimating system 300 calculates a first position radical (x) by applying the TOAs, the difference values, and the position coordinates of the base stations to the linear equation of Equation 8 (S103).

Here, the position estimating system 300 does not know real distances rₙ between the mobile terminal 200 and each base station, and it is therefore difficult to exactly calculate Q.

Accordingly, the position estimating system 300 calculates Q by applying TOA \tilde{r}ₙ of the base stations to Equation 7 rather than rₙ between the mobile terminal 200 and each base station and calculates the first position radical.

Further, when calculating the first position radical, the position estimating system 300 estimates distances \hat{r}ₙ between the mobile station 200 and each base station.

The estimation distances \hat{r}ₙ between the mobile station 200 and each base station are calculated with the following Equation 9.

\hat{r}ₙ=\sqrt{(xₙ−\hat{x})²+(yₙ−ŷ)²+(zₙ−\hat{z})²} (Equation 9)

Here, (\hat{x},ŷ,\hat{z}) represents position coordinates of the mobile terminal 200 based on the first position radical.

When the estimation distances \hat{r}ₙ between the mobile station 200 and each base station are calculated, the position estimating system 300 recalculates Q by applying the estimation distance \tilde{r}ₙ to Equation 7 rather than rₙ between the mobile terminal 200 and each base station (S104).

Then, the position estimating system 300 calculates a second position radical x by applying the difference values between a square TOA of the reference station and each of squared TOAs of the other base stations, the position coordinates of the base stations, and the recalculated Q to Equation 8 (S105).

Finally, the position estimating system 300 estimates the position of the mobile terminal 200 based on the second position radical.

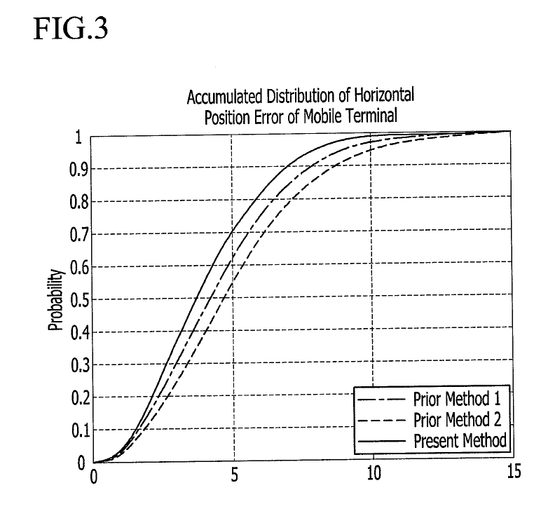

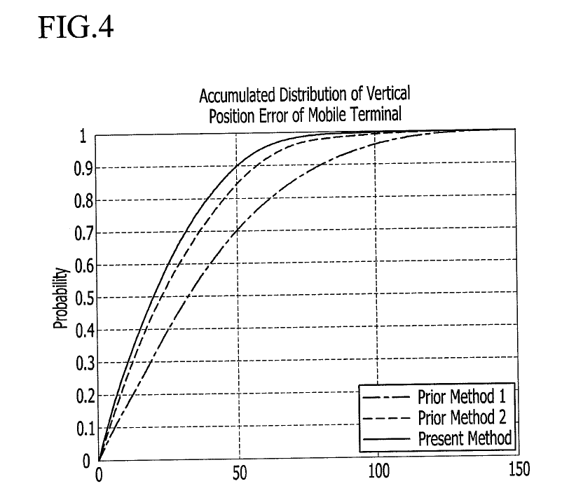

FIG. 3 shows a graph that compares an accumulated distribution of horizontal position error of the mobile terminal 200 according to the exemplary embodiment of the present invention with that of the prior art. FIG. 4 shows a graph that compares an accumulated distribution of vertical position error of the mobile terminal 200 according to the exemplary embodiment of the present invention with that of the prior art.

Referring to FIGS. 3 and 4, it is known that the position estimating method of the exemplary embodiment of the present invention has much improved accuracy in estimating a position by comparison with the prior art that uses a prior method 1 using an AML (Approximate Maximum Likelihood Localization) algorithm and a prior method 2 using a CH algorithm,

The above-described embodiments can be realized through a program for realizing functions corresponding to the configuration of the embodiments or a recording medium for recording the program in addition to through the above-described device and/or method, which is easily realized by a person skilled in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for estimating a position of a mobile terminal in a wireless network, the method comprising:
obtaining a signal arrival time and position coordinates of a first base station and a signal arrival time and position coordinates of a second base station;
calculating a difference value between a squared signal arrival time of the first base station and a squared signal arrival time of the second base station; and
estimating the position of the mobile terminal by using the difference value, the position coordinates of the first base station, the position coordinates of the second base station, and a measurement error covariance to the signal arrival time of the first base station and the signal arrival time of the second base station.

2. The method of claim 1, wherein the signal arrival time is represented with a distance between the mobile station and a corresponding base station and a measurement error of the time of signal arrival.

3. The method of claim 2, wherein the obtaining includes receiving the signal arrival time that represents how long it takes for a signal transmitted from the mobile terminal to arrive at the first base station, from the first base station, and the signal arrival time that represents how long it takes for a signal transmitted from the mobile terminal to arrive at the second base station, from the second base station.

4. The method of claim 1, wherein the estimating includes:
calculating the measurement error covariance using the signal arrival times;
calculating a first position radical by using the difference value, the position coordinates of the first base station, the position coordinates of the second base station, and the measurement error covariance;
recalculating the measurement error covariance based on the first position radical;
calculating a second position radical by using the difference value, the position coordinates of the first base station, the position coordinates of the second base station, and the recalculated measurement error covariance; and
estimating the position of the mobile terminal based on the second position radical.

5. The method of claim 4, wherein the recalculating includes:
calculating an estimation distance between the mobile terminal and the first base station and an estimation distance between the mobile terminal and the second base station based on the position coordinates of the first base station, the position coordinates of the second base station, and the first position radical; and
recalculating the measurement error covariance based on the estimation distance between the mobile terminal and the first base station and the estimation distance between the mobile terminal and the second base station.
